(19) United States
(12) Patent Application Publication
(10) Pub. No.: US 2025/0137089 A1
(43) Pub. Date: May 1, 2025

(54) CONSOLIDATOR SYSTEM AND METHOD FOR PROCESSING FEED MATERIALS

(71) Applicant: CONTINUUM POWDERS CORPORATION, Cloverdale, CA (US)

(72) Inventors: MATTHEW CHARLES, CLOVERDALE, CA (US); PAUL MEESE, HEALDSBURG, CA (US); JEFF McINTIRE, Castro Valley, CA (US); RON HENNON, Cloverdale, CA (US); JONATHAN NUTTALL, Santa Rosa, CA (US)

(73) Assignee: CONTINUUM POWDERS CORPORATION, Cloverdale, CA (US)

(21) Appl. No.: 18/925,173

(22) Filed: Oct. 24, 2024

Related U.S. Application Data
(60) Provisional application No. 63/546,570, filed on Oct. 31, 2023.

(51) Int. Cl. C22B 7/00

(52) U.S. Cl. CPC C22B 7/003

(57) ABSTRACT

A consolidator system for processing feed materials includes a reactor vessel having a sealed process chamber, a rotatable indexing table in the process chamber having a plurality separate melting hearths; a melting system in thermal communication with the melting hearths configured to melt a feed material in the melting hearths into a molten metal; a feeding system configured to feed the feed material into the melting hearths; and a collection system configured to collect consolidated metal pucks from the melting hearths. The consolidator system also includes a fluid cooling system in fluid communication with the melting hearths configured to cool the feed material into molten form into the consolidated metal pucks in solid form. The consolidator system also includes a sensing system and a control system configured to control the feeding system, the indexing table and the melting system using input from the sensing system.

### CROSS REFERENCE TO RELATED APPLICATION

This application claims priority from U.S. Provisional No. 63/546,570, filed Oct. 31, 2023, which is incorporated herein by reference.

### FIELD

This disclosure relates to a consolidator system and to a method for processing feed materials for recycle or disposal using the consolidator system.

### BACKGROUND

When producing a feed material, such as metal powders, using gas atomization, a gaussian distribution of powder sizes is often achieved. Atomization of certain materials may only yield a small percentage of powder in the desired particle size range. For example, when metal powders are produced for additive manufacturing (AM), the demand is highest for powders that meet the particle size range for use in laser powder bed fusion (LPBF) (e.g., 20-45 microns). Powders below 20 microns can be a health hazard and a hazardous waste. Powders from 45-106 microns can typically be used for other additive processes but at a reduced demand and reduced value. Powders above 106 microns have limited use, but also exhibit material properties that are similar to their pre-atomized condition. This makes these powders suited to re-feeding into an atomization process as well as other recycling processes. Unfortunately, due to their powdery form it is often technically challenging to use these out of spec powders as feed materials in atomization or recycling processes.

The present disclosure is directed to a system and method for processing feed materials, such as out of spec metal powders, metal chips and metal flakes, for producing consolidated metal pucks, suitable for manufacturing and recycling processes.

### SUMMARY

A consolidator system for processing feed materials includes a reactor vessel having a sealed process chamber. The consolidator system also includes a rotatable indexing table in the process chamber having a plurality separate melting hearths; a melting system having a heat source in thermal communication with the melting hearths configured to melt a feed material in the melting hearths into a molten metal; a feeding system configured to feed the feed material into the melting hearths; and a collection system configured to collect consolidated metal pucks from the melting hearths. The collection system includes a collection conduit and a scoop/claw mechanism configured to eject the consolidated metal pucks from the melting hearths into the collection conduit and/or to prepare a surface of the feed material in the melting hearths for melting. The consolidated metal pucks can have any desired shape including a shape selected to allow re-feeding into an atomization process.

The consolidator system also includes a gas system configured to form a controlled atmosphere in the process chamber by evacuating and then injecting inert gasses into the process chamber at a selected pressure. The consolidator system also includes a fluid cooling system in fluid communication with the melting hearths configured to cool the feed material in molten form into the consolidated metal pucks in solid form. The consolidator system also includes a control system configured to control the feeding system, the indexing table and the melting system. The control system can be configured to operate the consolidator system in a manual, automatic, or semi-automatic mode. In addition, the control system can be configured to operate the consolidator system continuously or in batch mode. The consolidator system also includes a sensing system having sensors configured to sense various operational parameters of the process, and to provide input to the control system. For example, the sensing system can include a feed material sensor configured to automatically adjust the amount of feed material being fed into the melting hearths.

In an illustrative embodiment, the heat source of the melting system includes a “dual mode” plasma torch that uses helium, argon, hydrogen, nitrogen, or other mixed gasses, and two separate power supplies configured for operation at selected current levels to produce a plasma arc. A first power supply can be configured to produce a standing non-transferred pilot-arc to produce a continuous stream of conductive ionized gas between the torch and the melt material. A second power supply can be employed to use this pre-existing conductive path to transfer current directly to the melt material. A variable resistance device can be employed in place of two power supplies, or a single power supply current can be apportioned between both torch modes. Alternately the melting system can include induction, resistance, electron beam, laser, or other heating systems configured to produce a discrete unit of feed material that can be re-atomized, recycled, or disposed of as high-density consolidated metal pucks.

The consolidator system can also include a container, such as a shipping container, configured to contain various components of the system, and permitting transport to any location, such as a recycling center, or a feed material collection center. The container can also be configured to provide storage, mounting locations for various components, access locations, as well as stairs, operating decks and support structures for the consolidator system. In addition, the consolidator system can also include separate supporting structures for various components of the system.

A method for processing a feed material includes the step of providing a consolidator system comprising a reactor vessel having a sealed process chamber, a rotatable indexing table in the process chamber having a plurality separate melting hearths, a melting system in thermal communication with the melting hearths configured to melt the feed material in the melting hearths, a feeding system configured to feed the feed material into the melting hearths, a sensing system configured to sense operational parameters, and a control system configured to control the feeding system, the indexing table and the melting system using input from the sensing system.

The method also includes the step of feeding a quantity of the feed material into a melting hearth using the feeding system at a feeding station of the indexing table, rotating the indexing table to place the melting hearth at a melting station of the indexing table, melting the feed material in the melting hearth into a molten metal at the melting station using the melting system, rotating the indexing table to place the melting hearth at one or more cooling stations of the indexing table, cooling the molten metal in the melting hearth into a consolidated metal puck, rotating the indexing table to place the melting hearth at an ejecting station of the indexing table, and ejecting the consolidated metal puck from the melting hearth at the ejecting station.

### BRIEF DESCRIPTION OF THE DRAWINGS

All of the figures are schematic in nature and may not be to scale.

FIG. 1A is a schematic partially transparent perspective view of a consolidator system for processing feed materials;

FIG. 1B is an enlarged schematic perspective view of a feed material that will be processed by the consolidator system;

FIG. 2 is a schematic side elevation view of the consolidator system;

FIG. 3 is a schematic partially transparent plan view of the consolidator system;

FIG. 4 is a schematic partially cut away plan view of an indexing table of the consolidator system;

FIG. 5 is a schematic cut away perspective view of a scoop/claw mechanism of the consolidator system;

FIG. 6 is a schematic perspective view with parts removed of the scoop/claw mechanism of the consolidator system;

FIG. 7A is a schematic bottom view of a consolidated metal puck fabricated using the consolidator system;

FIG. 7B is a schematic top view of the consolidated metal puck fabricated using the consolidator system;

FIG. 8 is a schematic perspective view of a transferred power supply of the consolidator system;

FIG. 9 is an electrical diagram of wiring for a transferred and non-transferred power supply of the consolidator system;

FIG. 10 is a schematic perspective view of dual transferred power supplies of the consolidator system;

FIG. 11 is a schematic diagram of a control system for the consolidator system.

### DETAILED DESCRIPTION

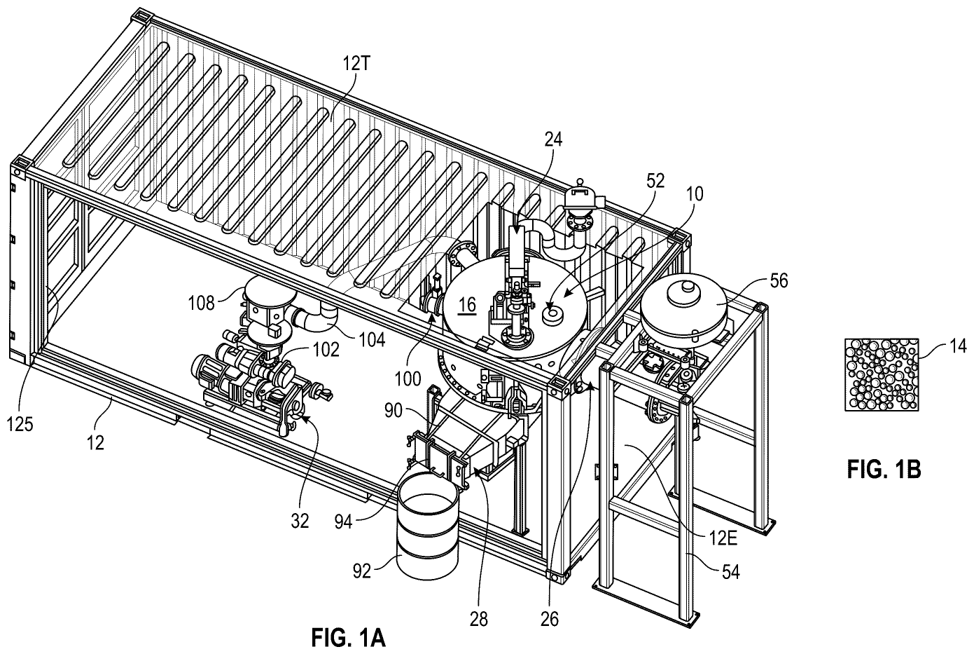

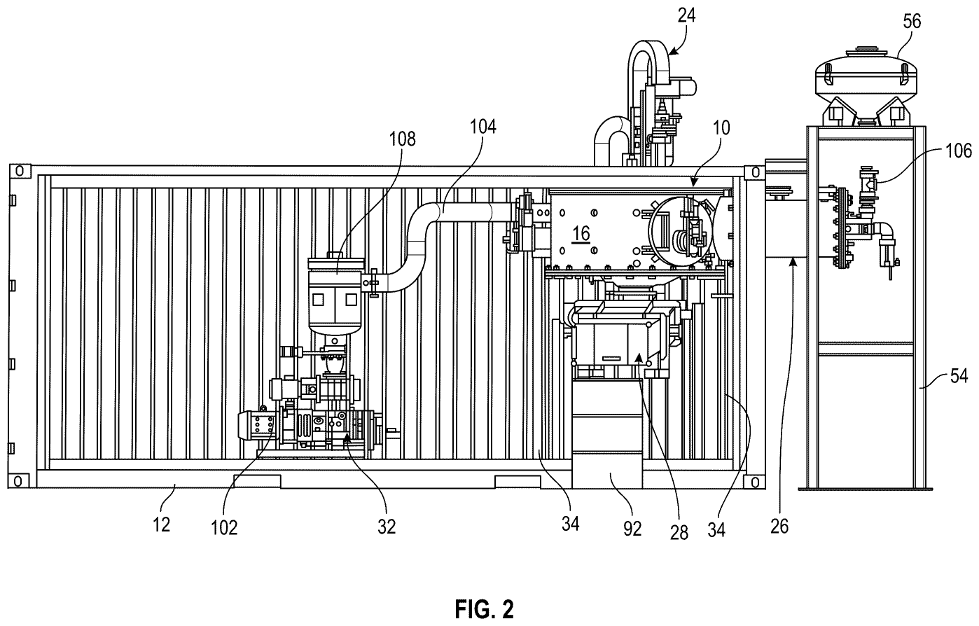

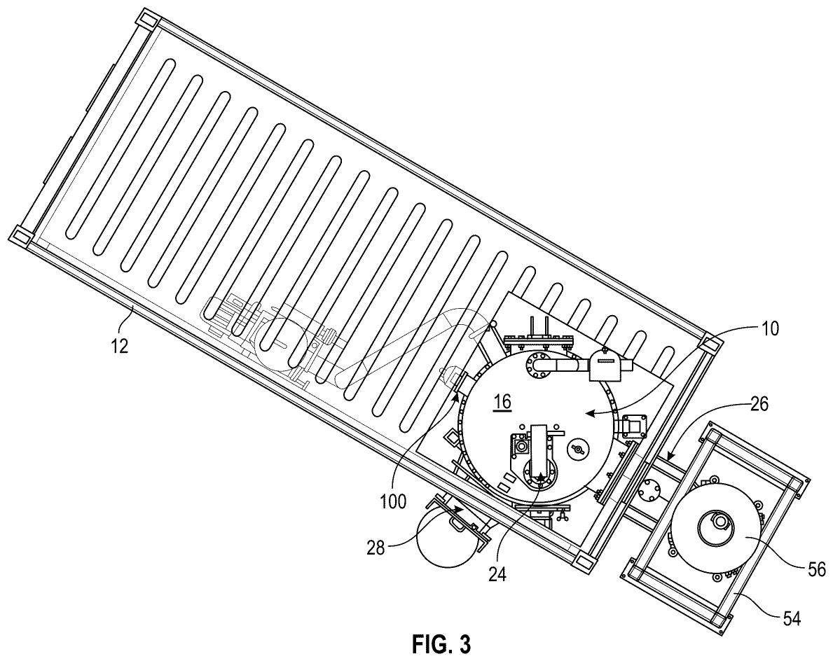

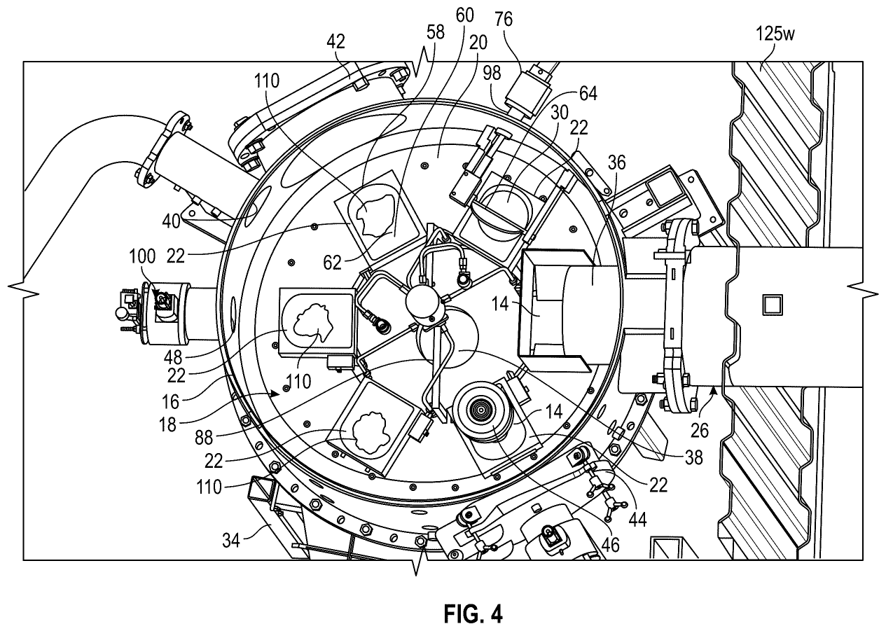

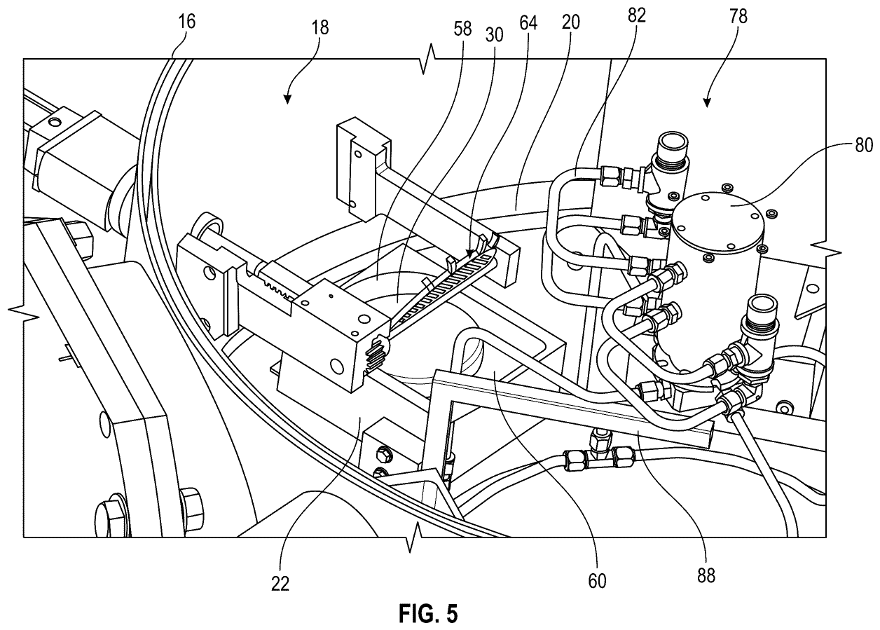

Referring to FIG. 1A, FIG. 1B, FIG. 2, FIG. 3, FIG. 4 and FIG. 5, a consolidator system 10 configured to consolidate materials for recycle or disposal is shown. In the illustrative embodiment, a feed material 14 (FIG. 1B) comprises recycled metal powder, such as an out of spec additive manufacturing (AM) grade metal powder. The consolidator system 10 can also be configured to process other materials, such as recycled metal chips, metal flakes, metal blocks and metal chunks, which have been produced as a product or by-product of various manufacturing operations.

In the illustrative embodiment, the consolidator system 10 is contained in a metal shipping container 12 (FIG. 1A), such that it can be transported to a desired location, such as a recycling center, or a battlefield location for military operations. In addition, the metal shipping container 12 (FIG. 1A) is configured to perform other functions, such as support for the consolidator system 10 and associated decks, stairs and walkways. Some of the features of the metal shipping container 12 (FIG. 1A) include corrugated sidewalls 12SW (FIG. 4) and a top side 12T (FIG. 1A), which also functions as a deck for accessing components of the consolidator system 10. In the illustrative embodiment, the metal shipping container 12 (FIG. 1A) includes an open front side 12S (FIG. 1A) and an open end 12E (FIG. 1A). The open front side 12S (FIG. 1A) and the open end 12E (FIG. 1A) can include mating removable solid walls (not shown) or doors (not shown). It is to be understood that the configuration of the metal shipping container 12 (FIG. 1A) is merely exemplary, as other arrangements can be used.

The consolidator system 10 includes a reactor vessel 16 (FIG. 1A) having a sealed process chamber 18 (FIG. 4). The consolidator system 10 also includes a rotatably mounted indexing table 20 (FIG. 4) in the process chamber 18 (FIG. 4) having a plurality separate melting hearths 22 (FIG. 4). The consolidator system 10 also includes a melting system 24 (FIG. 2) in thermal communication with the melting hearths 22 (FIG. 4) configured to melt the feed material 14 (FIG. 1B) in the melting hearths 22 (FIG. 4). Further details of the reactor vessel 16 (FIG. 1A), the indexing table 20 (FIG. 4) and the melting system 24 (FIG. 2) will be explained as the description proceeds.

The consolidator system 10 also includes a feeding system 26 (FIG. 1A) for feeding the feed material 14 (FIG. 1B) into the melting hearths 22 (FIG. 4). Depending on the feed material the feeding system 26 can include a screw mechanism or other powder feeder mechanisms. For example, feeding can be performed using a powder feeder as described in US Publication No. 2022-0136769 A1, which is incorporated herein by reference. The feeding system can also include a separate support structure 54 (FIG. 1A) and a feed material storage vessel 56 (FIG. 1A) for storing a quantity of the feed material 14 in a sealed atmosphere. As shown in FIG. 2, one or more load lock valves 106 and a removable or permanent conduit (not shown) can be used to transfer the feed material 14 from the feed material storage vessel 56 (FIG. 1A) into the feeding system 26. The load lock valves 106 and the feed material storage vessel 56 are configured to provide non-stop processing and unlimited batch size.

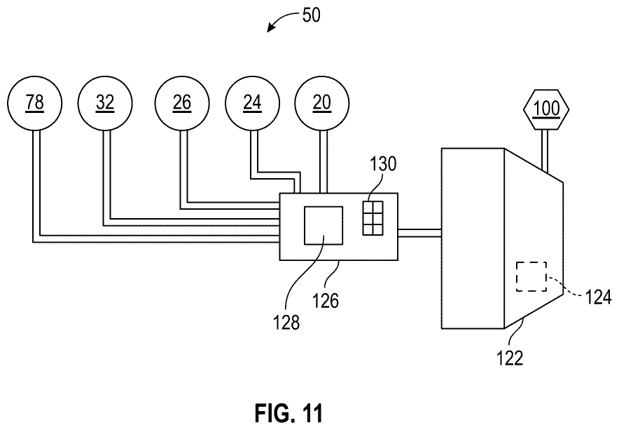

The consolidator system 10 also includes a collection system 28 (FIG. 1A) for collecting consolidated metal pucks 30 (FIG. 4) formed in the melting hearths 22 (FIG. 4) following a melting, cooling and ejecting processes. The consolidator system 10 also includes a gas system 32 (FIG. 1A) configured to maintain a controlled atmosphere in the process chamber 18 (FIG. 4) at a desired atmospheric pressure or negative pressure. The consolidator system 10 also includes a control system 50 (FIG. 11) for controlling various components of the consolidator system 10.

As shown in FIG. 2, the reactor vessel 16 comprises a hollow vessel having a generally cylindrical shape. In the illustrative embodiment, the reactor vessel 16 is formed of shaped metal plates having a bolted construction. The metal plates can comprise a structural metal such as steel, stainless steel or high temperature alloys, and can be coated or laminated with other materials, such as refractory materials. As shown in FIG. 1A, the top of the reactor vessel 16 comprises a solid metal plate wherein the melting system 24 is mounted. The sides of the reactor vessel 16 can comprise a curved plate in a circular shape, and the bottom of the reactor vessel can comprise one or more plates that form a sloped surface for the bottom of the process chamber 18. As shown in FIG. 2, the reactor vessel 16 is supported by four support legs 34.

As shown in FIG. 4, the reactor vessel 16 includes a feed material inlet 36 wherein the feed material 14 enters the process chamber 18 and is directed into the melting hearths 22 via the feeding system 26. The reactor vessel 16 also includes a consolidated metal puck outlet 38 configured to discharge the consolidated metal pucks 30 (FIG. 4) into the collection system 28 (FIG. 1A). The bottom of the reactor vessel 16 can be sloped downward towards the longitudinal axis of the cylindrical shape, substantially as shown in FIG. 2, to direct the consolidated metal pucks 30 through the consolidated metal puck outlet 38.

As also shown in FIG. 4, the reactor vessel 16 also includes a gas portal 40 wherein gases from the gas system 32 (FIG. 1A) exit and or enter the process chamber 18. Other gas outlets and inlets (not shown) can also be provided, for injecting and discharging other gases, such as inert gases and reactive gases, to and from the process chamber 18, and for controlling the atmosphere in the process chamber 18. For example, reactive gases can be used to remove impurities from the molten metal 110 (FIG. 4) and to purify the composition of the consolidated metal pucks 30 (FIG. 4). The process chamber 18 of the reactor vessel 16 is configured for sealed operation, such that all of the components associated with the process chamber, including the feeding system 26, the melting system 24 and the collection system 28, have sealing elements, such as valves and sealing gaskets. The reactor vessel 16 also includes a sealed view/access port 42, and a sealed access port 44 to a heat source 46 of the melting system 24. As shown in FIG. 1A, the gas system 32 includes a pump/motor 102, a tank 108 and a gas conduit 104 configured to evacuate the process chamber 18 (FIG. 4) and maintain a negative (i.e., vacuum) or positive operating pressure in a manner that is known in the art. By way of example, a representative pressure range in the process chamber 18 (FIG. 4) can be from 10 mtorr to a 5 psi positive gage pressure.

The reactor vessel 16 also includes a control portal 48 (FIG. 4) configured to provide access to the process chamber 18 and to contain at least some components of the sensing system 100 of the control system 50. By way of example, the sensing system 100 can include various sensors such as temperature sensors, pressure sensors and motion sensors, located in the control portal 48, or at various other locations of the consolidator system 10. For example, the sensing system 100 can also include a feed material sensor 52 mounted to the top of the reactor vessel 16 in electromagnetic communication with the process chamber 18, which is configured to automatically adjust the amount of feed material 14 being fed into the melting hearths 22. An exemplary feed material sensor 52 comprises a lidar or radar sensor configured to sense a quantity of the feed material 14 in the melting hearths 22. Another exemplary feed material sensor 52 comprises a weight measuring device, such as a load cell sensor, configured to weigh a discrete charge of the feed material 14, which can then be feed into the melting hearths 22. In this embodiment, a feeder mechanism, such as a rotary screw feeder can be configured to feed into a vibrator that incorporates the weight measuring device and feeds the discrete charge by vibration into the melting hearths 22, with all components being controlled by the control system 50.

Referring to FIG. 4, the indexing table 20 (FIG. 4) comprises a circular metal plate mounted within the process chamber 18 on a bearing assembly (not shown). The indexing table 20 (FIG. 4) is rotatable about a longitudinal axis of the reactor vessel 16 in either circular direction (e.g., clockwise or counterclockwise), and can be controlled to move through or stop at any angle (e.g., 0 degrees to 360 degrees), or to rotate continuously. A drive assembly (not shown) under control of the control system 50 (FIG. 11) controls the movement of the indexing table 20 (FIG. 4). Exemplary drive assemblies for the indexing table 20 (FIG. 4) include hydraulic drives, gear drives, and electric drives.

As shown in FIG. 4, the indexing table 20 includes six equally spaced melting hearths 22 formed of a material, such as an elemental material, an alloyed material, or a composite material that allows a high temperature material, such as titanium-based alloys, nickel-based alloys and moly-based alloys, to exist in a fully molten state. Exemplary materials for constructing the melting hearths 22 include metals, such as copper, tungsten, titanium and molybdenum, and refractory materials, such as graphite and ceramics. In the illustrative embodiment, each melting hearth 22 includes a melting cavity 62 having a semi-circular portion 58 that corresponds to the circular outline of the consolidated metal pucks 30, and a sloped portion 60 that allows the consolidated metal pucks 30 to be ejected from the melting hearths 22. The sloped portion 60 also aids in directing excess or over flowed feed material 14 in both powder form and molten form into the melting cavity 62. The melting hearths 22 can be further shaped to enhance the melting process and to minimize waste. For example, the localized area above, around, and below the melting cavity 62 can be shaped to allow any feed material 14 that has been displaced by the starting or ongoing melting process to be re-introduced into the molten metal 110 (FIG. 4) by gravity, thus allowing all or the bulk of the feed material 14 to be captured for the melting process. Alternately, cither magnetic, mechanical, gravimetric, gaseous, or other suitable apparatus can be used with the melting hearths 22 to insure that all of the feed material 14 is captured in the melting cavity 62 for melting into the molten metal 110 (FIG. 4).

Still referring to FIG. 4, the operation of the indexing table 20 can be described in terms of stations wherein various operations are performed. A dwell time at the various stations can be selected as required. In addition, the different operations at the stations can be repeated if required, until a melt and surface preparation process of the feed material 14, as well as a solidification process of the consolidated metal pucks 30, have been completed. A first station, termed herein as the fill station, is located at a 3 o'clock position of the indexing table 20, where a first melting hearth 22 is shown aligned with the feed material inlet 36 into the process chamber 18. At the first station, the feeding system 26 deposits a quantity of the feed material 14 (FIG. 1B) into the first melting hearth 22 located at the fill station. A sensing system 100 (FIG. 1A), can include various sensors including a feed material sensor 52 mounted on the top side of the reactor vessel 16, which is configured to automatically adjust the amount of feed material 14 being fed into the melting hearth 22 (FIG. 4). A second station, termed herein the melt station, is located at a 5 o'clock position of the indexing table 20, where a second melting hearth 22 is shown aligned with the heat source 46 of the melting system 24. At the melt station, the feed material 14 in the second melting hearth 22 is melted into a molten metal 110. A third station, a fourth station and a fifth station, termed herein cooling stations, are located at the 7-11 o'clock positions of the indexing table 20. A sixth station, termed herein an ejection station, is located at a 1 o'clock position of the indexing table, where a sixth melting hearth is shown aligned with a scoop/claw mechanism 64 configured to eject the consolidated metal pucks 30 from the melting hearths 22.

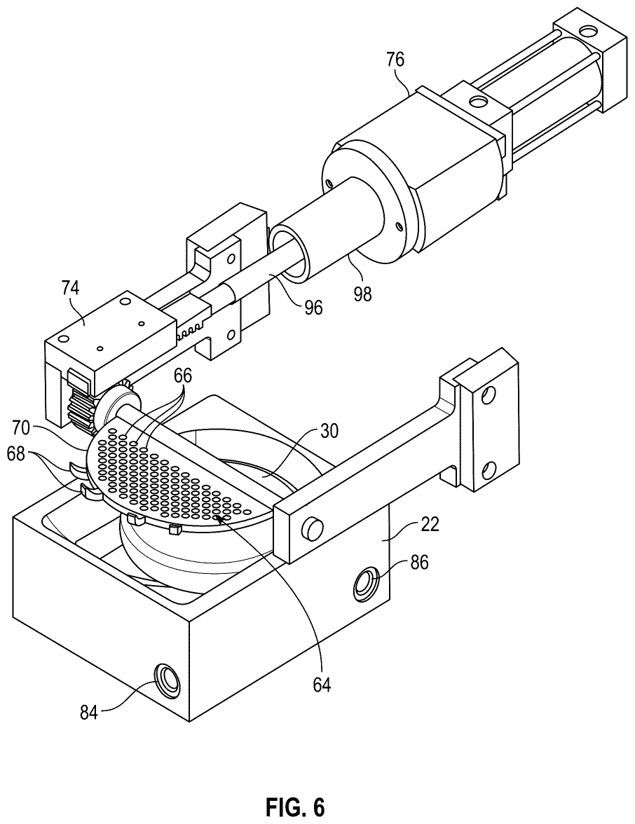

Referring to FIGS. 5 and 6, the scoop/claw mechanism 64 is shown separately. In addition to being configured to eject the consolidated metal pucks 30 from the melting hearths 22, the scoop/claw mechanism 64 is also configured to prepare a surface of the feed material 14 in the melting hearths 22 by contact with the molten metal 110 in the melting hearths 22, as well as contact with any un-melted powder metal. As shown in FIG. 6, the scoop/claw mechanism 64 includes a semicircular paddle 70 having a pattern of openings 66 therethrough. In addition, the scoop/claw mechanism 64 includes a plurality of curved claw members 68 located along the outer periphery of the semicircular paddle 70. As also shown in FIG. 6, the semicircular paddle 70 is rotatably mounted to a support member 72 at one end, and to a gear assembly 74 connected to a movable rod 96 of a hydraulic cylinder 76 at the other end. As shown in FIG. 4, the hydraulic cylinder 76 is fixedly mounted to an outside surface of the reactor vessel 16 and includes a scaling member 98 that seals the walls of the reactor chamber 16 from the penetration.

In FIG. 6, the semicircular paddle 70 is shown in a neutral position. Extension of the hydraulic cylinder 76 rotates and moves the claw members 68 on the semicircular paddle 70 in a first direction through any powder in the melting hearth 22 on the surface of the melt. This mechanical action prepares the surface of the feed material 14 for melting. In particular the paddled 70 is shaped and mounted for movements that form a depression on the powder surface that causes the molten metal 110 formed during the melting step to stay in the center of the melting hearth 22 and not to solidify at the periphery. If that happens the consolidated metal pucks 30 become hard to eject. Retraction of the hydraulic cylinder 76 rotates and moves the claw members 68 in an opposing direction into contact with the peripheral edge of a consolidated metal puck 30 for ejection from the melting hearth 22. In addition, the shape of the claw members 68 allows the scoop/claw mechanism 64 to perform either the surface preparation function or the puck ejection function. The ejection process works best if the solidified consolidated metal puck 30 is floating on a bed of un-melted loose powder, which essentially lubricates the ejection process. The different movements of the hydraulic cylinder 76, and thus the function of the scoop/claw mechanism 64, are under control of the control system 50 (FIG. 11). The sensing system 100 (FIG. 4) can be used to ascertain the condition of the feed material 14 in the melting cavity (e.g., molten or solid) and to communicate this information to the control system 50 (FIG. 11) to control the movement of the hydraulic cylinder 76. In alternate embodiments of the consolidator system 10, a separate station can be added to perform the surface preparation functions without the added table travel time to go back (e.g., rotate counter clock wise in FIG. 4) to rake and prep the feed material 14.

Referring to FIG. 5, a fluid cooling system 78 is operably associated with the melting hearths 22 for cooling the molten metal 110 (FIG. 4) into the consolidated metal pucks 30. The fluid cooling system 78 includes a rotary fluid sealing union 80, and a plurality of cooling fluid conduits 82. In addition, as shown in FIG. 6 the melting hearths 22 include a fluid inlet 84 and a fluid outlet 86 (or vice versa) as well as internal passageways (not shown) in fluid communication with the cooling fluid conduits 82. The rotary fluid sealing union 80 is mounted on a frame 88 to the reactor vessel 16 in a stationary position and is connected to a fluid source (not shown), such as a water source. The cooling fluid conduits 82 move with the indexing table 20 and the melting hearths 22.

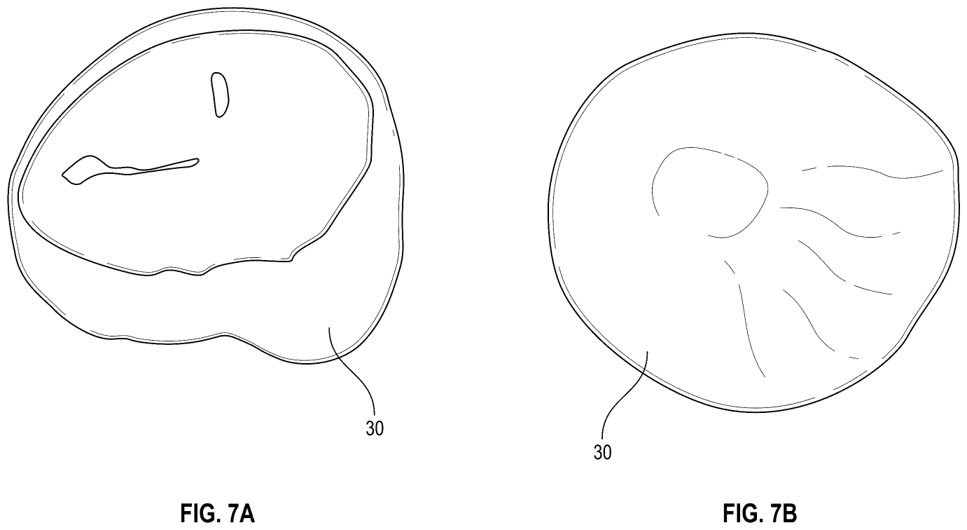

FIGS. 7A and 7B illustrate an exemplary configuration for the consolidated metal pucks 30. The consolidated metal pucks 30 have a generally circular peripheral configuration, rounded edges and a thickness determined by the size and shape of the melting cavities 62 (FIG. 4) of the melting hearths 22. Preferably the consolidated metal pucks 30 have a solid form prior to being ejected from the melting hearths 22. A chemical composition of the metal pucks 30 matches that of the feed material 14. With the feed material 14 comprising a metal powder made of alloys of metals, such as Fe, Cr, Ni, Mg, Mo, Al, Cu, Co and Ti, having a known chemical composition, the pucks 30 would have substantially the same chemical composition. This makes the consolidated metal pucks 30 valuable as recycled raw material for making different feed materials using atomization processes, and other processes as well. In the case of hazardous materials, the consolidated metal pucks 30 can also be disposed of in a more environmentally friendly manner than with the feed material 14 being in the form of a metal powder. In addition, the consolidated metal pucks 30 can be formed with an exact chemical composition by removing impurities using reactive gases during the melting processes. A size and shape of the consolidated metal pucks 30 can be selected as required. A preferred size and shape can be selected to allow use as a feed stock in an atomization process. In addition, with the feed material 14 comprising a metal powder, a controlled atmosphere can be used to retain most or all the mechanical and chemical qualities of the metal powder.

As shown in FIG. 4, the consolidated metal pucks 30 are ejected from the melting hearths 22 by the scoop/claw mechanism 64 into the consolidated metal puck outlet 38. As shown in FIG. 1A, the consolidated metal puck outlet 38 connects to a sealed collection conduit 90 of the collection system 28, which is configured to receive the consolidated metal pucks 30 that drop by gravity from the metal puck outlet 38. The sealed collection conduit 90 includes a removeable sealing plate 94 that seals the collection conduit 90. The sealing plate 94 can be removed for removing the consolidated metal pucks 30 from the collection conduit 90 into a collection container 92, such as a metal barrel. The sealed collection conduit 90 is sloped towards the collection container 92 to allow a gravity feed, but other mechanical or pneumatic collection systems can also be used.

As shown in FIG. 4, the melting system 24 (FIG. 2) includes the heat source 46, which is configured to melt the feed material 14 into the molten metal 110. In the illustrative embodiment, the heat source 46 comprises a plasma torch. The melting system 24 (FIG. 2) with the plasma torch heat source 46 can be constructed using equipment that is known in the art. In addition, the plasma torch heat source 46 can include components machined using 3D printing to allow features including but not limited to enhanced cooling, gas flow, physical dimensions, and material selection. U.S. Pat. Nos. 9,925,591 and 10,654,106, assigned to Applicant, disclose further details of melting systems that utilizes plasma torch heat sources. Both patents are incorporated herein by reference.

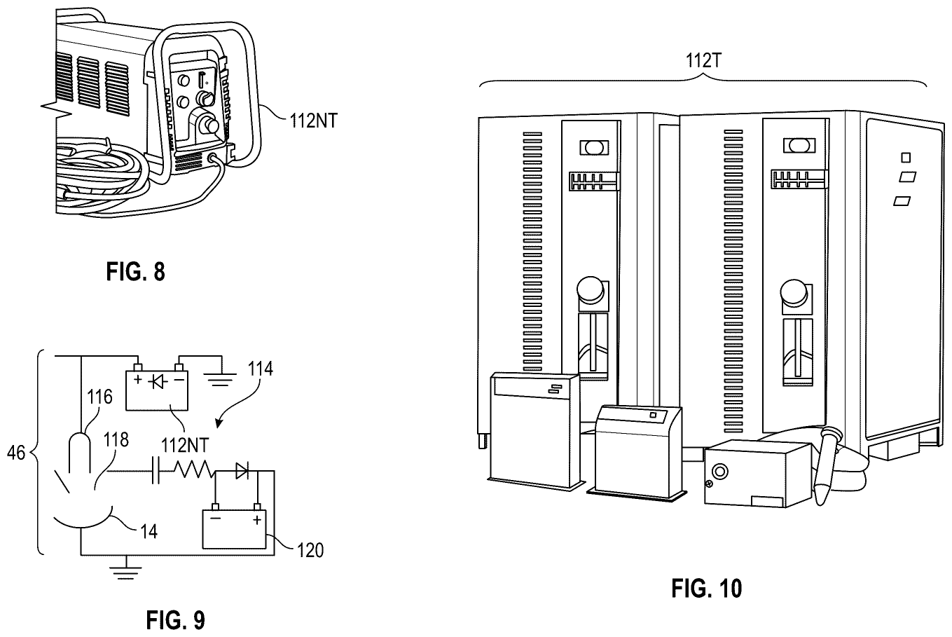

As shown in FIG. 8 and FIG. 9 the melting system 24 can also include a portable non-transferred arc power supply 112NT for the heat source 46. The non-transferred arc power supply 112NT is used to initiate a non-transferred pilot-arc. FIG. 9 illustrates an exemplary power circuit 114, which includes the non-transferred arc power supply 112NT in electrical communication with an electrode 116 of the heat source 46. The heat source 46 includes a nozzle 118 (FIG. 9) configured to direct the plasma onto the feed material 14 in the melting hearths 22. The nozzle 118 (FIG. 9) is in electrical communication with a starter supply 120 (FIG. 9). One suitable non-transferred arc power supply 112NT is commercially available from Baileigh Industrial of Manitowoc, Wisconsin, under the trademark “THERMAL DYNAMICS CUTMASTER”.

As shown in FIG. 10, the melting system 24 can also include a transferred arc power supply 112T. Transferred arc power supplies are commercially available from different plasma welding manufacturers in the US. The control system 50 can be configured to control power to the heat source 46 to adjust a torch height to sinter a top of the feed material 14 in the melting hearths 22 using the non-transferred arc power supply 112NT, and then to gradually engage the transferred arc from the transferred arc power supply 112T. Other suitable heat sources include an electric arc system, an induction system, a photon system, a radio frequency system or an electron beam energy system. The non-transferred arc power supply 112NT and the transferred arc power supply 112T form a “dual mode” power supply with non-transfer starting. With the feed material 14 in the form of a pure powder, it is difficult to melt the powder by conventional means. Powders are difficult to couple with induction melting and in plasma it is hard to start the arc on the powder. In addition, the plasma gas blows the powder out of the melting hearths 22.

As shown in FIG. 11, the control system 50 includes a CPU 122 having a program 122 (or cloud services) with a set of instructions for controlling the components of the consolidator system 10 including the indexing table 20, the melting system 24, the feeding system 26 including the feed material sensor 52, the gas system 32, and the fluid cooling system 78, as well as other components, using input from the sensing system 100. The control system 50 can also include a smart device 128 in signal communication with the CPU 122, such as a smart phone, a portable computer, or an i-pad, having a display screen 128 and a keypad 130 for inputting information. Alternately, the smart device 128 can be eliminated and the CPU 122 can be incorporated into a computer having the display screen 128 and keypad 130.
Example: Following is an exemplary operational sequence for the consolidator system 10.
1. Solid or powder feed material 14 (FIG. 1A) is brought to the process using the feed material storage vessel 56 (FIG. 1A) and the load lock valve 106 (FIG. 2).
2. The sealed collection system 28 (FIG. 1A) can be added or removed from the process by using the sealing plate 94 (FIG. 1A) without contaminating the controlled atmosphere in the process chamber 18 (FIG. 4).
3. The gas system 32 can be used to evacuate the atmosphere in the process chamber 18 (FIG. 4) on the initial startup and then the atmosphere can be backfilled with inert gas.
4. Feed material 14 (FIG. 1A) can be fed from the feeding system 26 (FIG. 4) into one of the melting hearths 22 (FIG. 4).
5. The control system 50 automatically adjusts the amount of feed material 14 (FIG. 1A) using the feed material sensor 52 (FIG. 1A). In addition, the control system 50 indexes the rotary indexing table 20 (FIG. 4) to the ejection station to prepare the surface of the feed material 14 using the scoop/claw mechanism 64 (FIG. 4) substantially as previously described.
6. The rotary indexing table 20 (FIG. 4) indexes the recently charged melting hearth 22 (FIG. 4) to the melt station below the heat source 46 (FIG. 4).
7. The non-transferred power supply 112NT (FIG. 8) is used to initiate a non-transferred pilot-arc. The control system 50 (FIG. 11) adjusts the torch height to sinter the top of the feed material 14 (FIG. 4) in the melting hearth 22 (FIG. 4) and then gradually engages the transferred-arc from the transferred-arc power supplies 112T (FIG. 10). After a set time, the heat source 46 (FIG. 4) will extinguish and the indexing table 20 (FIG. 4) will index to the next melting hearth 22 (FIG. 4), recently filled by the automated control system 50 (FIG. 11), using the feeding system 26 (FIG. 4).
8. The melting hearths 22 (FIG. 4) indexing through the cooling stations of the indexing table (FIG. 4) will be cooled by the fluid cooling system 78 (FIG. 5).
9. At the ejection station of the indexing table 20 (FIG. 4), the molten metal 110 will be cooled sufficiently to eject a consolidated metal puck 30 (FIG. 4) using the scoop/claw mechanism 64 (FIG. 4) substantially as previously described.
10. The process will continue requiring operator intervention only to reload the sealed feed vessel 56 (FIG. 1A) and empty the collection system 28 (FIG. 1A).

While a number of exemplary aspects and embodiments have been discussed above, those of skill in the art will recognize certain modifications, permutations, additions and subcombinations thereof. It is therefore intended that the following appended claims and claims hereafter introduced are interpreted to include all such modifications, permutations, additions and sub-combinations as are within their true spirit and scope.

What is claimed is:

1. A consolidator system for processing feed materials comprising:
a reactor vessel having a sealed process chamber;
a rotatable indexing table in the process chamber having a plurality separate melting hearths;
a melting system having a heat source in thermal communication with the melting hearths configured to melt a feed material in the melting hearths into a molten metal;
a feeding system configured to feed the feed material into the melting hearths;
a collection system configured to collect consolidated metal pucks from the melting hearths;
a gas system configured to form a controlled atmosphere in the process chamber by evacuating and then injecting gasses into the process chamber at a selected pressure;
a fluid cooling system in fluid communication with the melting hearths configured to cool the molten metal in the melting hearths into the consolidated metal pucks;
a sensing system configured to sense operational parameters; and
a control system configured to control the indexing table and the melting system using input from the sensing system.

2. The consolidator system of claim 1 wherein the collection system includes a scoop/claw mechanism configured to eject the consolidated metal pucks from the melting hearths into the collection system.

3. The consolidator system of claim 1 wherein the heat source comprises a heating system selected from the group consisting of a plasma arc system, an electric arc system, an induction system, a photon system, a radio frequency system and an electron beam energy system.

4. The consolidator system of claim 1 wherein the feed material comprises a metal selected from the group consisting of metal powder, metal chips, metal flakes, metal blocks and metal chunks.

5. The consolidator system of claim 1 wherein the feed material comprises a metal powder and the melting system is configured to melt the metal powder and to remove impurities during the melt using reactive gasses.

6. The consolidator system of claim 1 wherein the feeding system includes a sealed storage vessel and one or more load lock valves in flow communication with the sealed storage vessel configured to provide non-stop processing of the feed material.

7. The consolidator system of claim 1 wherein the heat source comprises a plasma torch configured for operation at a selected current level and configured for use with selected gasses or combination of gasses to produce a plasma arc.

8. The consolidator system of claim 1 wherein the heat source comprises a plasma torch includes having components machined using 3D printing to allow features including but not limited to enhanced cooling, enhanced gas flow, exact physical dimensions, and material selection.

9. The consolidator system of claim 1 wherein the consolidated metal pucks have a shape selected to allow re-feeding into an atomization process.

10. The consolidator system of claim 1 wherein each melting hearth includes a melting cavity and a localized area around the melting cavity that allows at least some of the feed material that can become displaced during operation of the melting system, to be reintroduced into the melting hearth.

11. The consolidator system of claim 1 wherein the feed material comprises a metal powder and the consolidated metal pucks possess mechanical and chemical qualities of the powder.

12. The consolidator system of claim 1 wherein the heat source comprises a plasma torch in electrical communication with a non-transferred arc power supply and a transferred arc power supply.

13. The consolidator system of claim 1 wherein the sensing system includes a feed material sensor configured to automatically adjust an amount of the feed material being fed by the feeding system into the melting hearths.

14. The consolidator system of claim 1 further comprising a metal shipping container configured for mounting components of the consolidator system and for transporting the consolidator system to a desired location.

15. The consolidator system of claim 14 wherein the metal shipping container is configured to provide storage, access locations, operating decks and support structures for the consolidator system.

16. The consolidator system of claim 1 wherein the fluid cooling system includes a rotary union connected to a fluid source and a plurality of hydraulic conduits in fluid communication with the rotary union and in fluid communication with passageways in the melting hearths.

17. A consolidator system for processing feed materials comprising:
a reactor vessel having a sealed process chamber;
a rotatable indexing table in the process chamber having a plurality separate melting hearths;
a melting system having a heat source in thermal communication with the melting hearths configured to melt a feed material in the melting hearths into a molten metal, the heat source comprising a dual mode plasma torch and two separate power supplies configured to produce a plasma arc, the separate power supplies comprising a non-transferred arc power supply and a transferred arc power supply;
a sealed feeding system configured to feed the feed material into the melting hearths;
a sealed collection system configured to collect consolidated metal pucks from the melting hearths;
a gas system configured to form a controlled atmosphere in the process chamber by evacuating and then injecting gasses into the process chamber at a selected pressure;
a fluid cooling system in fluid communication with the melting hearths configured to cool the molten metal in the melting hearths into the consolidated metal pucks in solid form;
a sensing system configured to sense operational parameters;
a control system configured to control the feeding system, the indexing table and the melting system using input from the sensing system; and
a container configured for mounting components of the consolidator system and for transporting the consolidator system.

18. The consolidator system of claim 17 wherein the plasma torch uses helium, argon, hydrogen, nitrogen, or other mixed gasses to produce the plasma arc.

19. The consolidator system of claim 17 wherein the collection system includes a scoop/claw mechanism configured to eject the consolidated metal pucks from the melting hearths into the collection system and to prepare a surface of the feed material in the melting hearths for melting.

20. The consolidator system of claim 17 wherein the fluid cooling system includes a rotary union connected to a fluid source and a plurality of hydraulic conduits in fluid communication with the rotary union and in fluid communication with passageways in the melting hearths.

21. A method for processing feed materials comprising:
providing a consolidator system comprising a reactor vessel having a sealed process chamber, a rotatable indexing table in the process chamber having a plurality separate melting hearths, a melting system having a heat source in thermal communication with the melting hearths configured to melt the feed material in the melting hearths, a feeding system configured to feed the feed material into the melting hearths, a sensing system configured to sense operational parameters, and a control system configured to control the feeding system, the indexing table and the melting system using input from the sensing system;
feeding a quantity of the feed material into a melting hearth using the feeding system at a fill station of the indexing table;
rotating the indexing table to place the melting hearth at a melting station of the indexing table;
melting the feed material in the melting hearth into a molten metal at the melting station using the melting system;
rotating the indexing table to move the melting hearth through one or more cooling stations of the indexing table;
cooling the molten metal in the melting hearth into a consolidated metal puck;
rotating the indexing table to place the melting hearth at an ejecting station of the indexing table; and
ejecting the consolidated metal puck from the melting hearth at the ejecting station.

22. The method of claim 21 wherein the consolidator system further comprises a collection system and further comprising collecting the consolidated metal puck following the ejecting step using the collection system.

23. The method of claim 21 wherein the heat source comprises a dual mode plasma torch in electrical communication with a non-transferred arc power supply and a transferred arc power supply.

24. The method of claim 21 wherein the sensing system comprises a feed material sensor configured to automatically adjust an amount of the feed material being fed by the feeding system into the melting hearths at the filling station.

25. The method of claim 21 wherein the feed material comprises a metal selected from the group consisting of metal powder, metal chips, metal flakes, metal blocks and metal chunks.
